(19) United States
(12) Patent Application Publication
(10) Pub. No.: US 2008/0082865 A1
(43) Pub. Date: Apr. 3, 2008

(54) INFORMATION RECORDING APPARATUS, INFORMATION PROCESSING APPARATUS, AND WRITE CONTROL METHOD

(75) Inventor: Yoshio Matsuoka, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 11/864,331

(22) Filed: Sep. 28, 2007

(30) Foreign Application Priority Data
Sep. 29, 2006 (JP) 2006-268811

(51) Int. Cl. G06F 11/16

(52) U.S. Cl. 714/42; 714/E11.062

(57) ABSTRACT

According to one embodiment, an information recording apparatus includes a disk recording medium, a nonvolatile memory provided with a plurality of memory blocks including a plurality of alternate blocks, a data write section which writes data to a memory block of an address assigned by the system, a data read section which reads the data from the memory block of the write-assigned address, a judgment section which determines whether or not the data read by the data read section is correctly written, and a control section which determines whether or not an unused alternate block is present by referring to the management information of the alternate blocks used in place of the memory blocks, when it is determined that the data is not correctly written, and notifying the system that data cannot be written to the write-assigned address, when it is determined that an unused alternate block is not present.

### CROSS-REFERENCE TO RELATED APPLICATIONS

This application is based upon and claims the benefit of priority from Japanese Patent Application No. 2006-268811, filed Sep. 29, 2006, the entire contents of which are incorporated herein by reference.

### BACKGROUND

1. Field

One embodiment of the present invention relates to an information recording apparatus in which a large-capacity disk recording medium such as a hard disk and a nonvolatile memory are combined, an information recording apparatus including this information recording apparatus, and a write control method.

2. Description of the Related Art

As is commonly known, in recent years, a hard disk is an information recording medium having a large capacity and high reliability, and is widespread in many fields as a recording medium for recording, for example, computer data, image data, audio data, and the like. Further, the hard disk has been downsized in shape so that it can be incorporated in a portable electronic device.

For this reason, as for a downsizing-aspiring magnetic disk device using a hard disk, it is planned to enhance the information write/read speed, and reduce the number of times of driving of the hard disk, i.e., the number of times of writing information or reading information to or from the hard disk by using a nonvolatile memory which can be used for high-speed writing and high-speed reading of information as a cache memory for the hard disk, thereby saving the use of a battery.

That is, in the magnetic disk device of such a type, by causing a nonvolatile memory to perform information writing and reading with respect to the external device, and causing a hard disk to perform information transfer to or from the nonvolatile memory, the speed of information writing or reading seen from the outside is enhanced and the number of times of driving of the hard disk is reduced, which is called hard disk drive (HDD) compatible with nonvolatile (NV)-cache, and is proposed.

The cell of a flash memory for storing information has a limit on the number of rewriting times and on the service life. In Jpn. Pat. Appln. KOKAI Publication No. 10-326227, a technique is disclosed in which when a memory region in use reaches an end of its service life or an error occurs therein, the memory region is switched to an unused alternate memory region to be used.

Incidentally, the operating system does not manage information in the cell of a flash memory that has reached an end of its service life. Accordingly, when there is no usable cell in the alternate memory region, a retry is repeated many times, and finally the operating system becomes inoperative as a result of a system error or a failure of the hybrid disk. Further, there is the possibility of the operation of the operating system becoming very heavy because of the excessive retries.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the external appearance of a computer as an information processing apparatus according to an embodiment of the present invention;

FIG. 2 is an exemplary block diagram showing the system configuration of the computer shown in FIG. 1;

FIG. 3 is an exemplary block diagram showing the configuration of a hybrid HDD and an operating system shown in FIG. 2; and

FIG. 4 is an exemplary flowchart showing procedures of write processing in the computer.

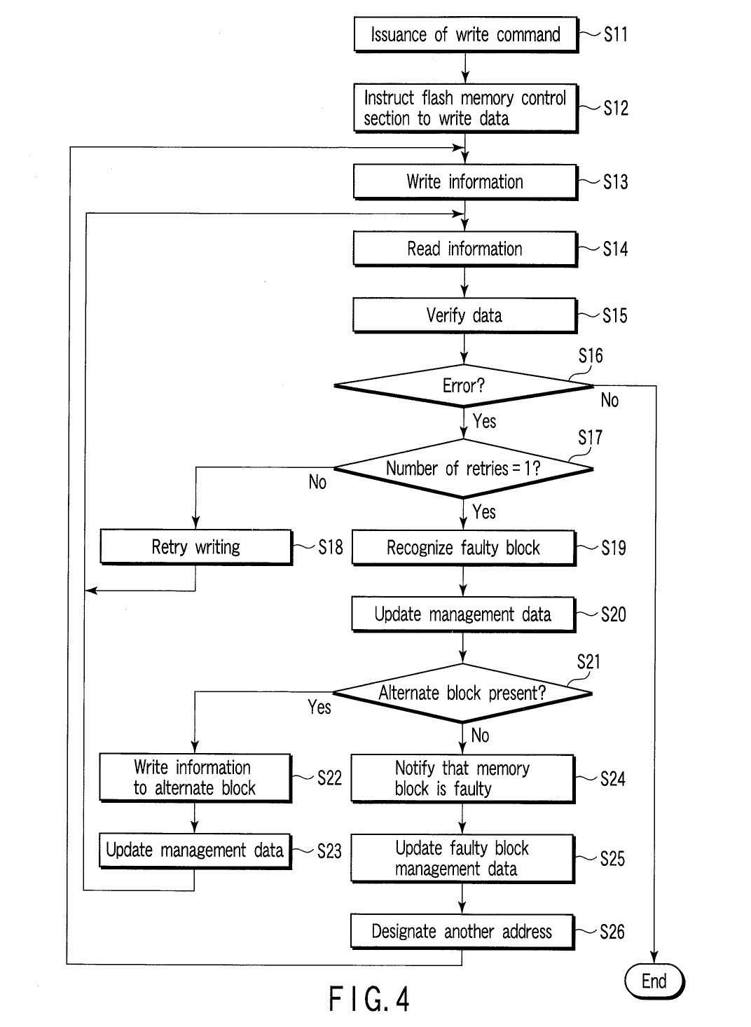

### DETAILED DESCRIPTION

Various embodiments according to the invention will be described hereinafter with reference to the accompanying drawings. In general, according to one embodiment of the invention, an information recording apparatus comprises a disk recording medium, a nonvolatile memory provided with a plurality of memory blocks including a plurality of alternate blocks, a management section which prepares management information of the alternate blocks used in place of the memory blocks, a data write section which writes data to a memory block of an address assigned by the system, a data read section which reads the data from the memory block of the write-assigned address after the data is written to the memory block of the write-assigned address, a judgment section which determines whether or not the data read by the data read section is correctly written, and a control section which determines whether or not an unused alternate block is present by referring to the management information, when it is determined that the data is not correctly written, and notifying the system that data cannot be written to the write-assigned address, when it is determined that an unused alternate block is not present.

An embodiment of the present invention will be described below with reference to the accompanying drawings.

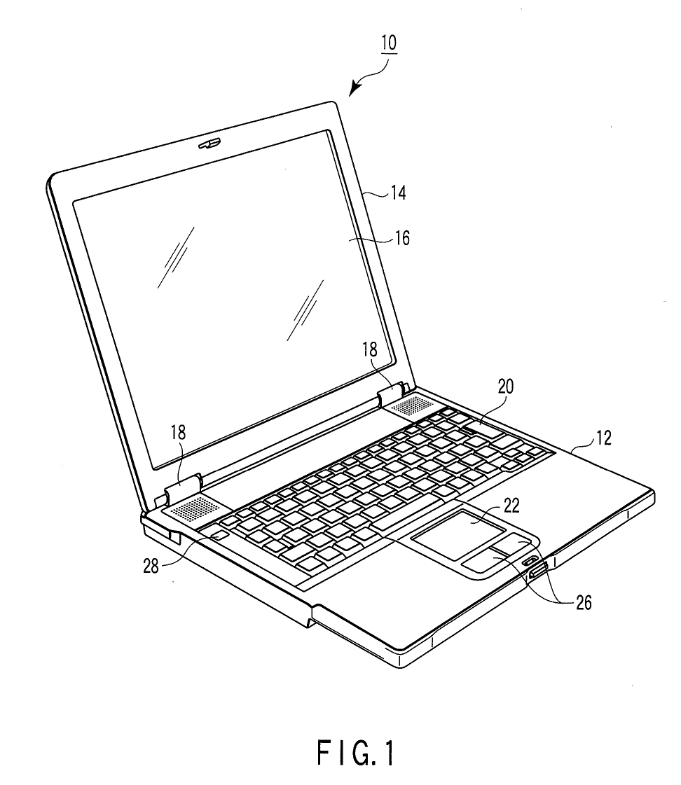

FIG. 1 is a view showing an example of a configuration of a notebook-sized personal computer serving as an information processing apparatus according to an embodiment of the present invention.

The personal computer 10 comprises a computer main body 12, and a display unit 14. A liquid crystal display (LCD) 16 which is a display section is incorporated in the display unit 14.

The display unit 14 is attached to hinges (support section) 18 provided at the innermost end part of the computer main body so that it can be rotatably changed in its position between a closed position in which the display unit 14 covers the top surface of the computer main body 12 and an open position in which the display unit 14 exposes the top surface of the computer main body 12.

The computer main body 12 has a thin box-shaped casing, and a keyboard 20 is provided at the center of the top surface of the casing. A palm rest is formed on the front side of the top surface of the casing of the computer main body 12. A touch pad 22 serving as operating means and touch pad control buttons 26 are provided at a substantially central part of the palm rest. A power button 28 for turning on/off the power of the computer main body 12 is disposed on the inner part of the top surface of the casing.

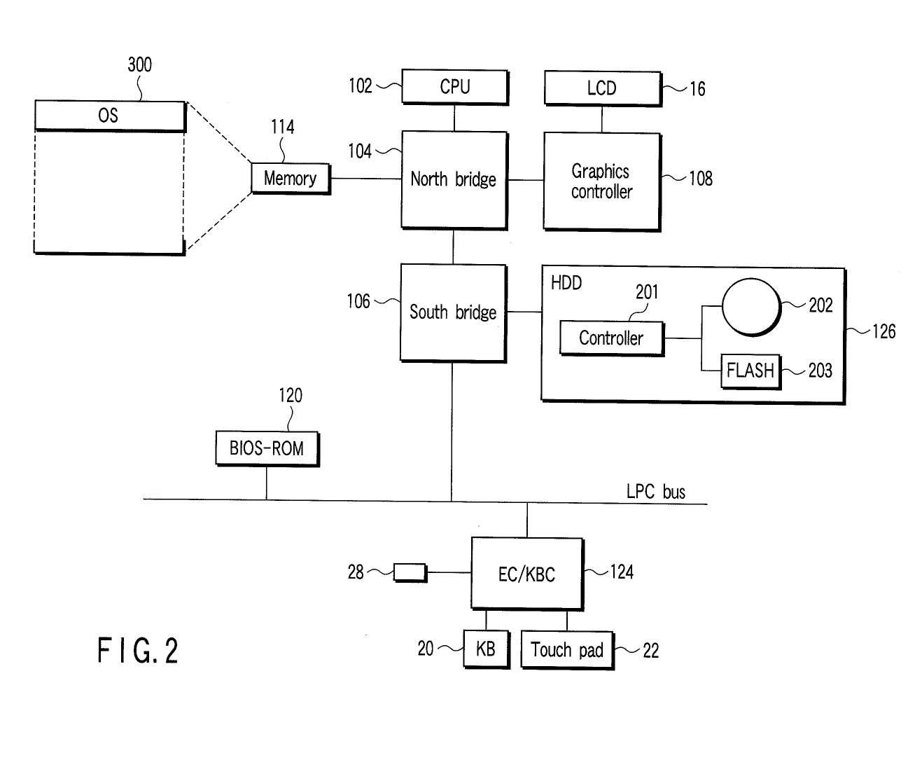

Next, an example of the system configuration of the computer system will be described below with reference to FIG. 2.

As shown in FIG. 2, the computer is provided with a CPU 102, a north bridge 104, a main memory 114, a graphics controller 108, a south bridge 106, a BIOS-ROM 120, a hybrid hard disk drive (HDD) 126, an embedded controller/keyboard controller IC (EC/KBC) 124, and the like.

The hybrid HDD 126 is provided with a controller 201, a magnetic disk 202, and a NAND type flash memory (FLASH) 203 serving as a nonvolatile memory. As for the flash memory 203, the controller 201 selectively accesses the magnetic disk 202 and the flash memory 203.

In the hybrid HDD 126, by using the flash memory 203 as a cache memory for the magnetic disk 202, it is possible to enhance the information writing speed and information reading speed, reduce the number of times of driving of the hard disk, i.e., the number of times of writing information or reading information to or from the hard disk, and save the use of battery power.

The CPU 102 is a processor provided for the purpose of controlling the operations of the computer, and executes various application programs including an operating system (OS) 300 loaded from the hybrid HDD 126 into the main memory 114.

Further, after loading the basic input output system (system BIOS) stored in the BIOS-ROM 120 into the main memory 114, the CPU 102 executes the system BIOS. The system BIOS is a program for controlling hardware.

The north bridge 104 is a bridge device for connecting a local bus of the CPU 102 and the south bridge 106 to each other. Further, the north bridge 104 has also a function of performing communication with the graphics controller 108 through an accelerated graphics port (AGP) bus or the like.

The graphics controller 108 is a display controller for controlling an LCD 16 used as a display monitor of the computer. The graphics controller 108 includes a video memory (VRAM), and generates an image signal for forming a display image to be displayed on the LCD 16 from display data depicted on the video memory by an OS/application program. The image signal generated by the graphics controller 108 is output to the line.

The south bridge 106 is connected to each of a peripheral component interconnect (PCI) bus and a low pin count (LPC) bus.

The embedded controller/keyboard controller IC 124 performs control of the touch pad 22 serving as input means and touch pad control buttons 26. The embedded controller/keyboard controller IC 124 is a one-chip microcomputer for monitoring and controlling various devices (a peripheral device, sensor, power supply circuit, etc.) irrespective of the system status of the computer 10.

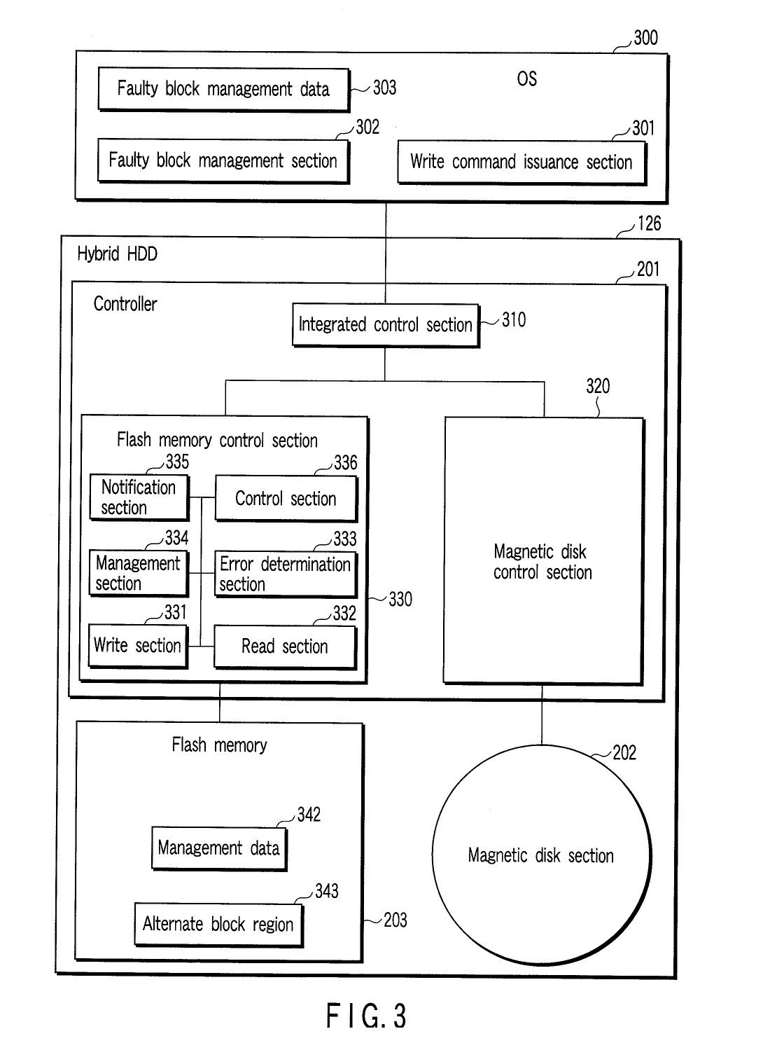

The configuration of the hybrid HDD 126 and a relationship between the hybrid HDD 126 and the operating system are shown in FIG. 3.

The operating system (OS) 300 includes a write command issuance section 301 for issuing a write command to the hybrid HDD 126, and a bad block management section 302 for managing bad block management data 303 in which an address of a bad block in the flash memory 203 is registered.

The flash memory 203 includes a plurality of memory blocks in which data is stored, and an alternate block region 343 to be substituted for a bad block to which data cannot be correctly written because of the expiry of the service life or the like is set in a part of the memory blocks. Further, management data 342 having address information on a bad block is stored in the flash memory 203.

The controller 201 includes an integrated control section 310, a magnetic disk control section 320, and a flash memory control section 330. The integrated control section 310 receives a command from the operating system, and performs control of the flash memory control section 330 and the magnetic disk control section 320. The magnetic disk control section 320 controls data writing and data reading of the magnetic disk section. The flash memory control section 330 controls data writing and data reading of the flash memory.

The flash memory control section 330 includes a write section 331, a read section 332, an error determination section 333, a management section 334, a notification section 335, and a control section 336. The write section 331 performs processing of writing data to a memory block of the flash memory 203. The write section 331 attaches an error correction code (ECC) to data and stores the data in the flash memory 203. The read section 332 reads data including the ECC from a memory block of a predetermined address. The error determination section 333 compares the read data with the ECC code, and performs determination of an error at the time of data writing or data correction. The error determination section 333 has a function of requesting, when it is determined that there is an error, the write section 331 to retry. The error determination section 333 has a counter for memorizing the number of requested retries.

The management section 334 manages memory blocks for which it is determined by the error determination section that the blocks are erroneous, and alternate blocks to be substituted for the erroneous memory blocks. The management data 342 prepared by the management section 334 is stored in the flash memory 203. The management data 342 includes information on a state where the alternate blocks are used, information for correlating the address of the erroneous block with the corresponding address of the alternate block, and the like. The notification section 335 has a function of, when all the alternate blocks are used, if an erroneous memory block occurs, notifying the operating system 300 of the address of the erroneous memory block.

Next, the processing of writing data to this hybrid HDD 126 will be described below.

The write command issuance section 301 of the operating system 300 assigns a block address and requests the hybrid HDD 126 to write information to the flash memory 203 (step S11). The write command issuance section 301 refers to the bad block management data 303 to assign an unregistered block address.

Upon receipt of the request from the write command issuance section 301, the integrated control section 310 instructs the flash memory control section 330 to write data to the assigned block address (step S12).

The write section 331 generates an ECC from the data. Then, the write section 331 writes information prepared by adding the ECC to the data to a assigned memory block in the flash memory 203 (step S13). The read section 332 reads the written information (data+ECC) from the memory block (step S14). The error determination section 333 decodes the ECC in the read information. The error determination section 333 compares the data in the read information and the decoded data with each other, and verifies the data items (step S15).

On the basis of the results of the comparison and verification, the error determination section 333 determines whether or not an error is present in the read information (step S16). When it is determined that the data is correctly written (No in step S16), the processing is terminated.

When it is determined that the data is not correctly written (Yes in step S16), the error determination section 333 refers to the counter in which the number of retries is memorized to determine whether or not a retry is performed. When it is determined that a retry is not performed (No in step S17), the error determination section 333 requests the write section 331 to retry information writing (step S18).

When it is determined in step S17 that a retry is performed (Yes in step S17), the error determination section 333 notifies the control section 336 that an error is present. The control section 336 recognizes the memory block to which data has been written as a defective memory block (step S19). Further, the control section 336 requests the management section 334 to update the information on the bad blocks stored in the management data, and the management section 334 updates the management data 342 (step S20).

Then, the control section 336 determines, by referring to the management data 342, whether or not an unused alternate block is present in the alternate block region 343 (step S21).

When it is determined that an alternate block is present (Yes in step S21), the control section 336 assigns the address of the unused alternate block, and requests the write section 331 to write the information that has not been written to the alternate block (step S22). The control section 336 requests that information for correlating the block address of the used alternate block with the address of the bad memory block should be added to the management data, and the management data should be updated (step S23).

Thereafter, the processing starting from step S14 is executed and the processing of data verification and the like is executed again.

When it is determined that an alternate block is not present (No in step S21), the control section 336 requests the notification section 335 to issue interrupt notification. The notification section 335 issues interrupt notification to the operating system 30 so as to notify the operating system 30 that the memory block of the assigned block address is bad (step S24).

The bad block management section 302 registers information on the notified block address in the bad block management data 303 in the magnetic disk section 202 so as to update the bad block management data 303 (step S25). Further, the write command issuance section 301 assigns a different block address previously assigned so as to instruct to write data (step S26). Then, the processing is returned to step S13, and write processing, verification processing, and the like are executed.

When an alternate block is not present in the hybrid HDD 126, if a bad block to which data cannot be correctly written because of the expiry of the service life or the like occurs, it is possible for the operating system to recognize the address of the bad block by notifying the operating system of the interrupt. Further, the error determination processing is performed within the hybrid HDD 126, and the operating system is notified of the determination result, whereby the access error processing speed is enhanced.

The operating system manages the address of a recognized bad block, whereby it is possible to prevent the bad block from being accessed, prevent the operation of the operating system from being stopped, and prevent the operation of the operating system from becoming heavy.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording apparatus comprising:
a disk drive comprising a hard disk recording medium;
a nonvolatile memory comprising a plurality of memory blocks and a plurality of alternate memory blocks;
a management section configured to prepare management information for the alternate blocks when the alternate memory blocks are used in place of the memory blocks;
a data write section configured to write data to at least one of the memory blocks according to a write-assigned address;
a data read section configured to read the data from the at least one memory block corresponding to the write-assigned address after the data is written;
a judgment section configured to determine whether or not the data read by the data read section is correctly written; and
a control section configured to refer to the management information to determine, when it is determined that the data is not correctly written, whether or not at least one of the alternate memory blocks is unused, the control section further configured to generate a notification that the data cannot be written to the write-assigned address when it is determined that an unused alternate memory block is not present.

2. The information recording apparatus according to claim 1, wherein the data write section is configured to write the data to at least one of the unused alternate memory blocks when it is determined that at least one of the alternate memory blocks is unused, the information recording apparatus further comprising a table preparation section configured to prepare a table in which an address of the at least one alternate memory block to which the data is written and the write-assigned address are correlated.

3. The information recording apparatus according to claim 1, wherein the data write section is configured to generate an error correction code from the data, and is configured to write the error correction code to the nonvolatile memory together with the data.

4. An information processing apparatus comprising:
an information recording apparatus including:
a disk recording medium;
a nonvolatile memory provided with a plurality of memory blocks and a plurality of alternate memory blocks;
a management section configured to prepare management information for the alternate memory blocks when the alternate memory blocks are used in place of the memory blocks;
a data write section configured to write information to a memory block according to a write-assigned address;
a data read section configured to read the data from the at least one memory block corresponding to the write-assigned address after the data is written;
a judgment section configured to determine whether or not the data read by the data read section is correctly written;
a control section configured to refer to the management information to determine, when it is determined that the data is not correctly written, whether or not at least one alternate memory block is unused, the control section further configured to generate a notification that that the data cannot be written when it is determined that an unused alternate memory block is not present; and
a bad block management section configured to prepare bad block management data in which the write-assigned address is registered.

5. The information processing recording apparatus according to claim 4, wherein the data write section is configured to write the data to at least one of the unused alternate memory blocks when it is determined that at least one of the alternate memory blocks is unused, and the information recording apparatus further comprises a table preparation section configured to prepare a table in which an address of the at least one alternate memory block to which the data is written and the write-assigned address are correlated.

6. The information processing recording apparatus according to claim 4, further comprising an instructing section configured to instruct the information recording apparatus to write the data to a nonvolatile memory having an address different from the write-assigned address in accordance with the notification.

7. The information processing recording apparatus according to claim 4, wherein the data write section is configured to generate an error correction code from the data, and is configured to write the error correction code to the nonvolatile memory together with the data.

8. A write control method for writing data to an information recording apparatus including a disk recording medium, and a nonvolatile memory provided with a plurality of memory blocks for writing data and a plurality of alternate memory blocks, comprising:
writing information to a memory block of a write-assigned address;
reading the data from the memory block of the write-assigned address after the data is written;
judging whether or not the read data is correctly written; and
judging, when it is determined that the data is not correctly written, whether or not at least one unused alternate memory block is available by referring to alternate block management information indicative whether the alternate memory blocks are used; and
generating a notification that the data cannot be written to the write-assigned address when it is determined that an unused alternate memory block is not available.

9. The write control method according to claim 8, further comprising:
writing the data to at least one of the unused alternate memory blocks when it is determined that at least one unused alternate memory block is available; and
storing information in which an address of the alternate memory block to which the data is written and the write-assigned address are correlated.

10. The write control method according to claim 8, further comprising:
generating an error correction code from the data; and
writing the error correction code to the nonvolatile memory together with the data.
